(19) United States
(12) Patent Application Publication
(10) Pub. No.: US 2009/0047854 A1
(43) Pub. Date: Feb. 19, 2009

(54) METHOD OF MANUFACTURING A PRODUCT PART BY USING A COMPOSITE FIBRE SHEET AND APPLYING PLASTIC TO THIS SHEET

(76) Inventors: Michel Bleeker, Groningen (NL); Marinus Arnoldus Martinus Vugts, Drachten (NL); Johannes Bernardus Valentinus Opzeeland, Dronten (NL); Christopher John Stanton, Drachten (NL); Johanna Adriana Franciscus Spaan, Amersfoort (NL); Martinus Folkertsma, Drachten (NL)

Correspondence Address: PHILIPS INTELLECTUAL PROPERTY & STANDARDS, P.O. BOX 3001, BRIARCLIFF MANOR, NY, 10510, US

(21) Appl. No.: 12/278,975

(22) PCT Filed: Feb. 2, 2007
(86) PCT No.: PCT/IB2007/050353

§ 371 Date: Aug. 11, 2008

(30) Foreign Application Priority Data
Feb. 13, 2006 (EP) 06101584.8

(51) Int. Cl. B32B 27/12; B29C 70/08; B29C 45/14

(52) U.S. Cl. 442/286; 156/60; 264/257; 264/328.1; 442/394

(57) ABSTRACT

In a process of manufacturing a product part (50), a composite fibre sheet (10) is applied, and one side of the composite fibre sheet (10) is covered with a plastic material. First of all, the composite fibre sheet (10) is shaped by heating the sheet (10) and pressing the sheet (10) in a shaping mold. Subsequently, the composite fibre sheet (10) is placed in an injection mold into which liquid plastic is introduced for the purpose of applying a plastic layer (12) to the sheet (10). In this way, as a result of the application of the composite fibre sheet (10), a product part (50) having a high stiffness and a pleasant look and feel is obtained, which is preferred over a product part having a plastic body filled with reinforcing fibres.

The present invention relates to a method of manufacturing a product part, especially a product part which is intended to be used in various types of products for domestic appliances, such as coffee makers, and in various types of personal care products, such as shavers and trimmers. In a particular embodiment, the product part may be a covering piece which is intended to be positioned at an outer side of a product.

US 2004/0247853 A1 discloses a method of manufacturing a laminated component, in particular a vehicle body part, comprising the steps of providing a substrate; depositing liquid plastic onto one side of the substrate by placing the substrate in a mold and introducing the liquid plastic into the mould; allowing the liquid plastic to cure in order to form a solid plastic layer; and releasing the component comprising the substrate and the plastic layer from the mold. The substrate is a foil of, for example, a thermoplastic material or another appropriate material such as aluminium, aluminium alloy, composites, etc. The plastic comprises polyurethane, for example. The method may comprise an additional step of mixing the liquid plastic with a plurality of reinforcing fibres such as glass fibres, which is performed prior to the depositing step.

In respect of many products, it is important that the product has an appealing visual appearance. In case the product is a hand-held device, it is also important that the product has an appealing tactile appearance. Many products comprise plastic covering pieces, and in order to enhance the visual appearance of such pieces, techniques like coloring, lacquering, aquadeck, printing, etc. are used.

Furthermore, a technique known as in-mold-decoration may be used for the purpose of enhancing the appearance of a product. According to this technique, a covering piece of a product is manufactured by placing a plastic foil in a mold, and subsequently molding plastic onto the foil. In the process, fibres may be incorporated into the plastic. The foil can either be flat or pre-formed, depending on the desired shape of the covering piece.

The known techniques as described in the foregoing have limitations with regard to the visual appearance and tactile appearance that can be achieved. In practice, it appears that the application of fibres such as glass fibres, carbon fibres or aramide fibres into the plastic does not yield the required effect. Improvements may be realized by using textures, leather surfaces or leather-like surfaces, for example, but the results are still not satisfying. Therefore, it is an object of the present invention to provide a method of manufacturing a product part, on the basis of which covering pieces having a more appealing outer surface are obtained, i.e. an outer surface having a nice appearance which cannot be realized by means of the techniques known and used thus far.

Another disadvantage of using reinforcing fibres and incorporating these fibres into plastic in a process of manufacturing a product part is that the impact resistance of the plastic is decreased. Therefore, it is also an object of the present invention to provide a method of manufacturing a product part, on the basis of which it is possible to obtain product parts having a fibrous surface, without compromising the impact resistance.

The objects of the present invention are achieved by a method of manufacturing a part of a product chosen from a group of products comprising products for domestic appliance and personal care products, comprising the steps of providing a composite fibre sheet, and applying a plastic layer to the composite fibre sheet.

According to the present invention, in the process of manufacturing a product part, a composite fibre sheet is used, which is provided with a plastic layer.

In case the product part is a covering piece that is intended to be positioned at an outer side of a product, one side of the composite fibre sheet, which will be referred to as visible side, serves to give the product part a nice visual appearance. According to one possibility, the plastic layer is applied to another side of the composite fibre sheet. In such a case, a product part having both a nice visual appearance and a pleasant tactile appearance is obtained. However, it is also possible to apply the plastic layer to the visible side of the composite fibre sheet, provided that the plastic layer is at least partially transparent.

The application of the composite fibre sheet has many important advantages, of which a number are mentioned in the following.

In the first place, by using a composite fibre sheet, it is possible to benefit from the presence of continuous fibres, which is not the case in a situation in which fibres are incorporated into plastic.

In the second place, an improved visual appearance of the product part is obtained, which is important in case the product part is intended to serve as a covering piece of a product. Furthermore, it is also very well possible to realize an improved tactile appearance of the product part in case the visible side of the composite fibre sheet is left uncovered. In this way, an appealing look and feel can be given to a product having a housing which comprises the product part.

In the third place, the composite fibre sheet contributes to the constructional stiffness of the product part, making the product part less susceptible to deformation. Moreover, when a plastic is filled with reinforcing fibres, the impact resistance of the plastic is lower, but by using a composite fibre sheet and applying a plastic layer to this sheet, the impact resistance is kept at an acceptable level.

Normally, a composite fibre sheet cannot contain functional elements such as snap-fit joints, screw poles, sealing rims, light guides, etc. This fact constitutes a limitation to the application range of such sheets. However, when the method according to the present invention is applied, a plastic layer is applied to the composite fibre sheet, and all necessary constructional elements can be integrated into this layer. Therefore, an important achievement of the present invention resides in the fact that the stiffness and appearance of a composite fibre sheet are combined with the capabilities and freedom in respect of construction and design as offered by plastic.

In many applications, rather than being flat, the product part needs to have a predetermined shape with bent portions. When the method according to the present invention is applied, it is possible to realize any required shape of the product part by giving the composite fibre sheet a predetermined shape that is adapted to the required shape of the product part to be manufactured on the basis of the composite fibre sheet, prior to the step of applying a plastic layer to the composite fibre sheet. Preferably, a thermoplastic composite fibre sheet is used, the composite fibre sheet being heated for the purpose of shaping it. According to a practical possibility, a tool having at least two parts is used in the process of shaping the composite fibre sheet, the composite fibre sheet being pressed between surfaces of the parts of the tool.

According to a first possibility, the plastic layer is applied to the composite fibre sheet by placing the composite fibre sheet in a mold for injection moulding, introducing liquid plastic into the mold, and allowing the liquid plastic to solidify. As soon as the plastic layer is capable of maintaining its shape without the support of the mould, the product part which is formed on the basis of the composite fibre sheet and the plastic may be released from the mold.

According to a second possibility, the plastic layer is applied to the composite fibre sheet by providing a plastic substrate and connecting the plastic substrate and the composite fibre sheet to each other. For the purpose of establishing a connection between the plastic substrate and the composite fibre sheet, any suitable connecting technique may be used. A practical example of such a connecting technique is gluing.

In case the product part needs to have a predetermined shape, it is preferred to use a plastic substrate having a shape that is adapted to this predetermined shape of the product part. The composite fibre sheet may be pre-formed, or the composite fibre sheet may be shaped against the plastic substrate when the plastic substrate and the composite fibre sheet are connected to each other. In practice, the latter possibility is particularly applicable when the shape of the product part is relatively simple, i.e. when the product part does not comprise strongly cylindrical portions, sharp curves, or the like.

The composite fibre sheet may be any suitable type of sheet, for example, a sheet comprising woven glass fibre and a thermoplastic matrix. In general, a composite fibre sheet comprises a matrix material and reinforcing fibres, the matrix material and the reinforcing fibres remaining separate and distinct on a macroscopic level while forming a single component. The matrix material surrounds and supports the reinforcing fibres by maintaining their relative positions, while the reinforcing fibres impart their special mechanical, electrical and physical properties to enhance the matrix properties.

The present invention also relates to a method of manufacturing a product chosen from a group of products comprising products for domestic appliance and personal care products, which method comprises a step of manufacturing a housing of the product. Furthermore, the present invention also relates to a part for a product and a product having a housing.

For the sake of completeness, it is noted that the product part may have any suitable shape. Apart from that, the product part may comprise one or more holes, for example, for letting through a control button of a product in which the product part is applied. In case the product part is a covering piece, the product part may be intended for covering a product entirely, or for covering only a portion of a product. The product is chosen from a group of products comprising products for domestic appliance and personal care products, for example, a shaver, a trimmer, a clipper, an epilator, a depilator, a toothbrush, a hair dryer, a hair dryer accessory, an iron, a coffee maker, a kettle, a home beer tapping device, a vacuum cleaner, a fryer etc.

The present invention will now be explained in greater detail with reference to the Figures, in which equal or similar parts are indicated by the same reference signs, and in which:

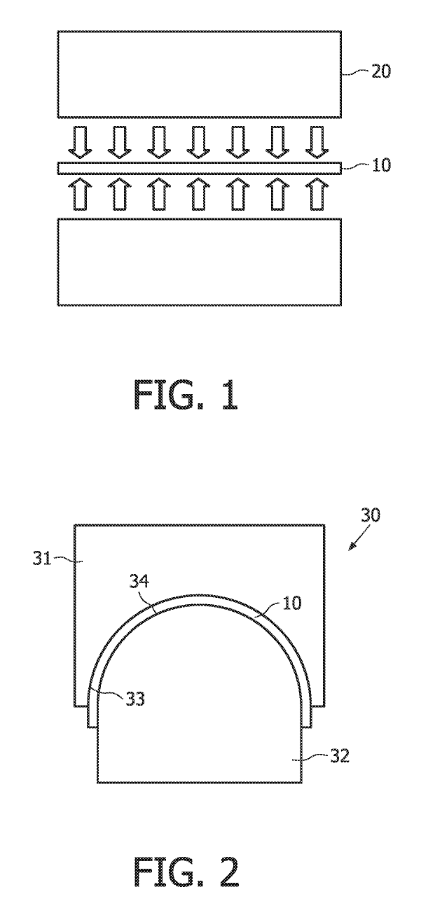

FIG. 1 diagrammatically shows a composite fibre sheet, located in a heater;

FIG. 2 diagrammatically shows the composite fibre sheet shown in FIG. 1, located in a shaping mould;

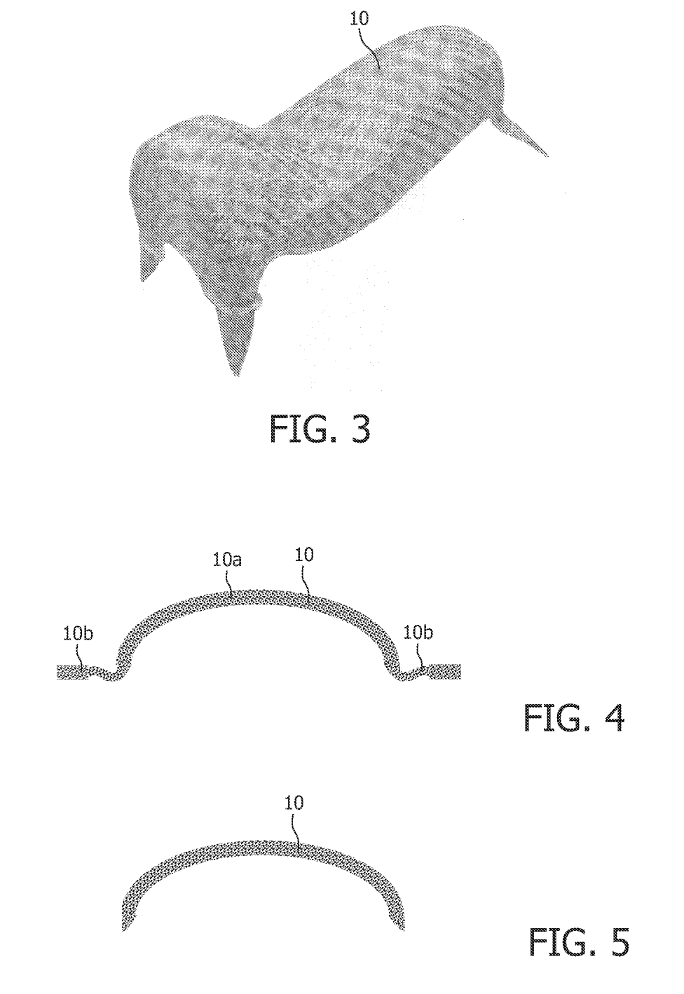

FIG. 3 shows an example of a shaped composite fibre sheet in a rough version;

FIG. 4 diagrammatically shows an example of a cross-section of another shaped composite fibre sheet in a rough version;

FIG. 5 diagrammatically shows an example of a cross-section of the shaped composite fibre sheet shown in FIG. 4, in a cut and trimmed version;

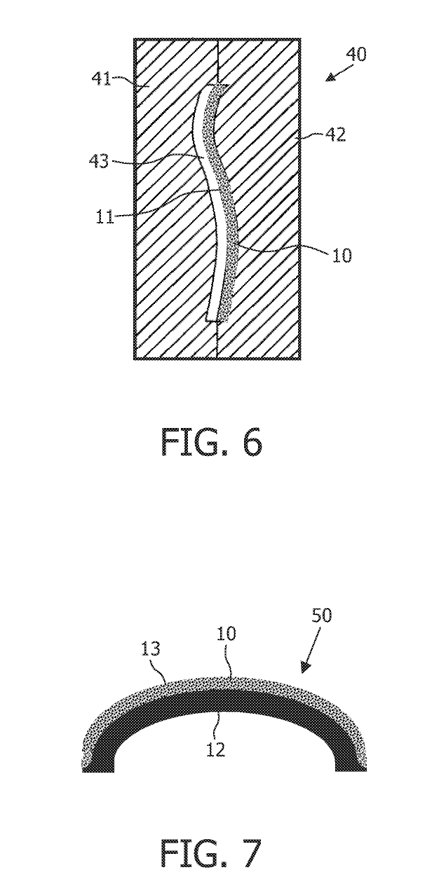

FIG. 6 diagrammatically shows a side view of a section of an injection mould and a shaped composite fibre sheet that is located in the injection mould; and

FIG. 7 diagrammatically shows a cross-section of a covering piece having a composite fibre sheet and a plastic layer.

It is noted that, in the following, a process of manufacturing a covering piece that is intended to constitute an outer part of a housing of a product will be explained. This particular process is to be regarded only as one of many possibilities that exist within the scope of the present invention, as the present invention is suitable to be applied in respect of any type of product part.

A first step of the process of manufacturing a covering piece is illustrated in FIG. 1. In this first step, a thermoplastic composite fibre sheet 10 is provided and placed in a heater 20. The heater 20 may be an infrared heater, for example. In FIG. 1, the heat supplied to the composite fibre sheet 10 during operation of the heater 20 is diagrammatically indicated by means of arrows directed towards the sheet 10. As a result of the heating process that takes place in the heater 20, the composite fibre sheet 10 is put into a state in which the sheet 10 is deformable.

The thermoplastic composite fibre sheet 10 may comprise any type of fibre and any type of thermoplastic resin, and may be either a woven or non-woven mat. The fibres may be at least one type of fibres, chosen from a group of glass fibres, carbon fibres, or aramide fibres, for example. The thermoplastic resin may be ABS (acrylonitrile butadiene styrene), PP (polypropylene), PC (polycarbonate), PBT (polybutylene terephthalate), PA (polyamide), or the like.

When the composite fibre sheet 10 has reached a state in which it is deformable, the sheet 10 is removed from the heater 20, and placed in a mold 30, for the purpose of giving the sheet 10 a predetermined shape. The step of shaping the composite fibre sheet 10 in the mold 30 is illustrated in FIG. 2.

The shaping mold 30 comprises two mold parts 31, 32. During the shaping process, the composite fibre sheet 10 is pressed between these mold parts 31, 32. In the example shown, the shaping mold 30 is adapted to bend the composite fibre sheet 10. In particular, one mold part 31, which will be referred to as receiving mold part 31, comprises a concave shaping surface 33, whereas another mold part 32, which will be referred to as die 32, comprises a convex shaping surface 34. In a practical embodiment of the shaping mold 30, the receiving mold part 31 may be manufactured from a metal, whereas the die 32 may be manufactured from a metal or rubber.

After the process of pressing the composite fibre sheet 10 between the shaping surfaces 33, 34 of the mold parts 31, 32 has taken place, and the sheet 10 has been cooled down to a temperature at which the sheet 10 is capable of maintaining its shape without the support of the shaping mold 30, the mold parts 31, 32 are moved apart, and the sheet 10 is removed from the shaping mold 30. The cooling process may be accelerated by taking appropriate measures for actively cooling the composite fibre sheet 10 in the shaping mould 30.

An example of a shaped composite fibre sheet 10, in a rough version, i.e. immediately after it has been removed from the shaping mold 30, is shown in FIG. 3. In this example, the composite fibre sheet 10 comprises glass fibres, and is intended to be part of a covering piece for a shaver.

A cross-section of another example of a shaped composite fibre sheet 10, in a rough version, is shown in FIG. 4. In FIG. 5, the same cross-section of the same, shaped composite fibre sheet 10 is shown, in a cut and trimmed version, which is a final version of the composite fibre sheet 10. In the example shown, in the rough version, the shaped composite fibre sheet 10 comprises a smoothly curved central portion 10a and two border portions 10b extending on opposite sides of the central portion 10a. During a cutting action, the two border portions 10b are removed.

In a next step, which is illustrated in FIG. 6, the shaped composite fibre sheet 10 is placed in an injection mold 40, which comprises two mold parts 41, 42. In a situation in which the injection mold 40 is closed, i.e. a situation in which the mold parts 41, 42 are placed against each other, a cavity 43 is present in the mold 40, which is suitable for containing the shaped composite fibre sheet 10, while leaving one side 11 of the sheet 10 free. This side 11 is covered with a thermoplastic resin by introducing the resin in a liquid state into the space offered by the cavity 43 of the injection mold 40. Suitable resins are ABS resins, PP resins, PC resins, PBT resins, PA resins, or the like, or blends of these resins.

The thermoplastic resin is allowed to solidify, so that a solid plastic layer 12 is obtained. At that stage, the covering piece 50 is ready. A cross-section of a covering piece 50 having a shaped composite fibre sheet 10 and a plastic layer 12 is shown in FIG. 7. In the example shown, the plastic layer 12 is non-transparent. Thus, when the covering piece 50 is used in a process of manufacturing a product such as a shaver, the covering piece 50 is positioned such that the composite fibre sheet 10 is located at the outer side of the product, so that the plastic layer 12 is hidden from view by the sheet 10.

The covering piece 50 may be regarded as a plastic body supporting a fibrous surface, the fibrous surface being constituted by an uncovered side 13 of the composite fibre sheet 10, and the plastic body being constituted by the plastic layer 12. The composition of the composite fibre sheet 10 may be chosen such that the appearance of the sheet 10 is appealing to a user, at least as far as the look and the feel of the sheet 10 are concerned. Hence, by applying the covering piece 50 in a product, as part of a housing of the product, such that the covering piece 50 is positioned at an outer side of the product, it is possible to realize a product having a pleasant look and feel.

The covering piece 50 may be applied as an outer housing part of any type of product, for example, a shaver, a trimmer, a clipper, an epilator, a depilator, a toothbrush, a hair dryer, a hair dryer accessory, an iron, a coffee maker, a kettle, a home beer tapping device, a vacuum cleaner, a fryer etc.

The fibrous surface does not necessarily need to be located at the outer side of a product in which the covering piece 50 is applied, as it is possible to have a plastic layer 12 that is at least partially transparent. In such a case, the plastic layer 12 may be located at the outer side of the product, so that a user of the product is capable of seeing the fibrous surface through the plastic layer 12. In this way, i.e. by providing a plastic layer 12 that is at least partially transparent and provides a view of the composite fibre sheet 10 through the plastic layer 12, an appealing visual effect may be obtained. Moreover, the transparent plastic layer 12 protects the fibrous surface from scratches and other forms of damage.

When a transparent plastic layer 12 is applied to one side of the composite fibre sheet 10, and this layer 12 is intended to be located at an outer side of a product in which the covering piece 50 is to be incorporated, it is possible to apply another plastic layer to another side of the composite fibre sheet 10. The additional plastic layer may contribute to the stiffness of the covering piece 50.

It is noted that due to the presence of the composite fibre sheet 10, the stiffness of the covering piece 50 is relatively high. The same is true of the impact resistance of the covering piece. Nevertheless, elements providing (?) structural functionality like stiffening ribs and snap joints may be added to the covering piece 50, for example, by placing the covering piece 50 into an injection mould, and covering the plastic layer 12 with a plastic resin. For the sake of completeness, it is noted that such a process is also known as insert moulding.

It will be clear to a person skilled in the art that the scope of the present invention is not limited to the examples discussed in the foregoing, but that several amendments and modifications thereof are possible without deviating from the scope of the present invention as defined in the attached claims.

In the foregoing, a method of manufacturing a product part 50 is disclosed. According to this method, a composite fibre sheet 10 is applied, and at least one side 11 of the composite fibre sheet 10 is covered with a plastic material. First of all, in a practical way of carrying out the method, the composite fibre sheet 10 is shaped by heating the sheet 10 and pressing the sheet 10 in a shaping mold 30. Subsequently, the composite fibre sheet 10 is placed in an injection mold 40 into which liquid plastic is introduced for the purpose of applying a plastic layer 12 to the sheet 10. In this way, as a result of the application of the composite fibre sheet 10, a product part 50 having a high stiffness and a pleasant look and feel is obtained, which is preferred over a product part having a plastic body filled with reinforcing fibres.

1. Method of manufacturing a part of a product chosen from a group of products comprising products for domestic appliance and personal care products, comprising the steps of providing a composite fibre sheet (10) and applying a plastic layer (12) to the composite fibre sheet (10).

2. Method according to claim 1, wherein, prior to the step of applying the plastic layer (12) to the composite fibre sheet (10), the composite fibre sheet (10) is given a predetermined shape.

3. Method according to claim 2, wherein a thermoplastic composite fibre sheet (10) is used, and wherein the composite fibre sheet (10) is heated for the purpose of shaping the composite fibre sheet (10).

4. Method according to claim 2, wherein a tool (30) having at east two parts (31, 32) is used in the process of shaping the composite fibre sheet (10), and wherein the composite fibre sheet (10) is pressed between surfaces (33, 34) of the parts (31, 32) of the tool (30).

5. Method according to claim 1, wherein the step of applying the plastic layer (12) to the composite fibre sheet (10) is carried out by placing the composite fibre sheet (10) in a mold (40) for injection molding, introducing liquid plastic into the mold (40), and allowing the liquid plastic to solidify.

6. Method according to 1, wherein the step of applying the plastic layer (12) to the composite fibre sheet (10) is carried out by providing a plastic substrate and connecting the plastic substrate and the composite fibre sheet (10) to each other.

7. Method according to claim 6, wherein the plastic substrate and the composite fibre sheet (10) are connected to each other by means of gluing.

8. Method of manufacturing a product chosen from a group of products comprising products for domestic appliance and personal care products, comprising a step of manufacturing a housing of the product, which involves carrying out the method according to claim 1.

9. Part (50) for a product chosen from a group of products comprising products for domestic appliance and personal care products, comprising a composite fibre sheet (10) and a plastic layer (12) connected thereto.

10. Product part (50) according to claim 9, being a covering piece that is intended to be positioned at an outer side of a product.

11. Product chosen from a group of products comprising products for domestic appliance and personal care products, having a housing which comprises a product part (50) according to claim 10.
